(19) United States
(12) Patent Application Publication
(10) Pub. No.: US 2025/0135544 A1
(43) Pub. Date: May 1, 2025

(54) IMPROVING THE POSITIONAL ACCURACY OF THE ENERGY SUPPLY IN AN ADDITIVE MANUFACTURING APPARATUS

(71) Applicant: EOS GmbH Electro Optical Systems, Krailling (DE)

(72) Inventors: Alois LOHR, Bad Aibling (DE); Uwe STARR, Greifenberg (DE); Thomas MATTES, Gilching (DE); Alexander PRILLWITZ, München (DE); Michael GÖTH, München (DE)

(21) Appl. No.: 18/683,458

(22) PCT Filed: Jul. 18, 2022
(86) PCT No.: PCT/EP2022/070042

§ 371 Date: Feb. 13, 2024

(30) Foreign Application Priority Data
Aug. 13, 2021 (DE) 10 2021 208 911.9

(51) Int. Cl. B22F 10/31; B22F 10/36; B29C 64/393

(52) U.S. Cl. CPC B22F 10/31; B22F 10/36; B29C 64/393

(57) ABSTRACT

Disclosed is a calibration method for a layer-wise additive manufacturing apparatus. The method includes a control device, a layer application device, and an energy supply device. The energy supply device can be moved over the building field and a predefined target direction is specified for the energy supply device for this movement. The energy supply device includes a number of radiation emitters which are arranged along an arrangement direction transverse to the predefined target direction The control device specifies for the radiation emitters emission locations over the building field at which radiation is to be emitted. Depending on the positions, it is determined whether a deviation of a movement direction from the predefined target direction occurs in the movement of the energy supply device, and the control device is caused to specify other emission locations for radiation emitters depending on a determined deviation.

The present invention relates to a calibration method of an apparatus for the layer-by-layer additive manufacturing of three-dimensional objects and to an apparatus calibratable by such a calibration method for the layer-by-layer additive manufacturing of a number of three-dimensional objects.

Additive manufacturing apparatuses and associated methods to which the invention relates are generally characterized in that objects are manufactured in the same layer by layer by solidifying a shapeless building material (e.g. a metal or plastic powder). The solidification can be brought about, for example, by supplying thermal energy to the building material by means of irradiating the same with electromagnetic radiation or particle radiation (e.g. laser sintering (SLS or DMLS) or laser melting or electron beam melting). For example, in the case of laser sintering or laser melting, a laser beam is moved over those positions of a layer of the building material which correspond to the object cross section of the object to be manufactured in this layer, so that the building material is solidified at these positions. After the building material has been melted or sintered at a position by supplying thermal energy, the building material does no longer exist in a shapeless state after cooling, but rather is a solid. After all positions of an object cross section to be solidified have been scanned, a new layer of the building material is applied and likewise solidified at the positions corresponding to the cross section of the object in this layer.

The selective irradiation of the applied powder layer can be accomplished, for example, by deflecting a laser beam by means of a deflection device that is e.g. formed from galvanometer mirrors such that its point of incidence on the powder surface is moved over the positions to be solidified.

Alternatively, WO 2015/091485 A1 discloses an irradiation device (sometimes also called an exposure device) that contains a plurality of laser arrays. Each of these laser arrays is constructed from a plurality of individual VCSELs (vertical cavity surface-emitting lasers) that together are switched on or off. The laser arrays are imaged onto the powder surface by means of an optical element. By selectively switching the laser arrays on and off and moving the exposure device parallel to the powder surface, the entire powder layer can be selectively exposed. With such a system, which can also be referred to as a line exposure device, a selective irradiation process can take place more quickly, since different positions of the powder layer can be irradiated approximately simultaneously or at least with a large temporal overlap.

However, the inventors of the present application found that, when using a line exposure device, also new problems can arise with regard to the positional accuracy with which the radiation is supplied to the positions of the powder layer to be solidified. When using galvanometer mirrors for directing the radiation onto the powder layer, the positional accuracy with regard to the position of the point of incidence on the powder surface depends, inter alia, on how quickly the mechanics can convert the commands specified by the control device into angular movements. In contrast to that, when using a line exposure device, there is a completely different situation. Here, in contrast to the conventional use of galvanometer mirrors, a significantly larger mass, namely the entire exposure device, is moved.

It is therefore an object of the present invention to provide a method and an apparatus by which a high positional accuracy in the supply of the radiation to a layer of the building material can be achieved, when an additive manufacturing apparatus having a line exposure device is used.

The object is achieved by a calibration method according to claim 1 and an apparatus according to claim 10. Further developments of the invention are claimed in the dependent claims. In particular, an apparatus according to the invention can also be developed further by features of the methods according to the invention which are described below or in the dependent claims, and vice versa. Furthermore, the features described in connection with one apparatus according to the invention can also be used for a further development of another apparatus according to the invention, even if this is not explicitly stated.

In an inventive calibration method of an apparatus for a layer-by-layer additive manufacturing of a number of objects, the apparatus comprising:
a control device for controlling the layer-by-layer additive manufacturing process,
a layer application device which is adapted to provide a layer of a shapeless building material within a building field on a building base or on an already manufactured layer, and
an energy supply device which is adapted to solidify predetermined positions of the provided layer that are assigned to cross sections of the number of objects in this layer by supplying electromagnetic radiation,
   wherein the energy supply device is adapted to be moved over the building field for supplying electromagnetic radiation to the predetermined positions and a predefined target direction (X) is specified for the energy supply device for this movement, and
   wherein the energy supply device comprises a number of radiation emitters which are arranged along an arrangement direction (Y) transverse to the predefined target direction (X), and the control device specifies for the radiation emitters emission locations over the building field at which radiation is to be emitted, depending on the predetermined positions,
it is determined, whether a deviation of a movement direction (B) of the energy supply device from the predefined target direction (X) occurs in the movement of the energy supply device, and the control device is caused to specify other emission locations for radiation emitters depending on a determined deviation.

The present invention refers to the calibration of additive manufacturing apparatuses operating layer by layer, in which energy is selectively supplied as electromagnetic radiation to a layer of the building material. The working plane (also referred to as building plane) is a plane in which the upper side of the layer to which the energy is supplied lies, which usually is the uppermost layer of the layer stack forming during the layer-by-layer manufacturing. The building field is the area of the working plane in which a layer-by-layer manufacturing of objects can take place.

In particular, the invention refers to laser sintering or laser melting, wherein heat is supplied to the building material by means of radiation, so that the same melts at least partially and after cooling exists in a solid, no longer shapeless state, i.e. is solidified. Since the transitions between partial (i.e. superficial in the case of powder grains) melting (sintering) and complete melting (melting) are fluid, the terms sintering and melting are used synonymously in the present application and no distinction is made between sintering and melting.

Furthermore, it should be noted that the methods and apparatuses to which the present invention refers are concerned with the manufacturing of three-dimensional objects, in other words it does not relate to the formation of layers on carrier materials (coatings). Nevertheless, the use of body parts to which a partial volume of the complete part is supplemented by means of the additive manufacturing method shall also be included.

The shapeless building material can be a material in powder form or a paste-like material. It is preferably a polymer-containing building material.

It should also be noted at this point that not only one object but also a plurality of objects can be manufactured simultaneously by means of an additive manufacturing apparatus according to the invention. If the manufacturing of one object is mentioned in the present application, it is understood that the respective description can also be applied in the same manner to additive manufacturing methods and apparatuses in which a plurality of objects are manufactured simultaneously. Furthermore, in the present application the term “number” is always used in the sense of “one or more”. Furthermore, it should be noted that an object in an additive manufacturing process can also be only a component or a section of the actual object representing the end product.

For supplying the electromagnetic radiation to the building material, the energy supply device is moved in a plane above of the building field, which plane is in parallel to the building plane. If in practice there should occur inadvertent slight deviations from the parallelism of the planes, these can be corrected independently of the procedure described here or during the procedure described here. A predefined target direction (X) is specified for the movement of the energy supply device. This means that the movement is structurally limited to a linear movement in one dimension in the plane. Here, the term target direction (X) shall not necessarily imply that the movement can take place only in one direction in the plane. Rather, a movement in the opposite direction (quasi −X) will usually also be possible, although the energy supply device for the solidification of the total number of predetermined positions in a layer usually always moves in the same direction (i.e. not back and forth).

For each guidance of a linear movement in a target direction, it cannot be excluded that deviations of the movement direction B from the target direction occur, even with careful design of the components that guide the movement. According to the present procedure, it is therefore checked whether such a deviation from the movement direction occurs and the radiation supply for the selective solidification of the building material is corrected accordingly. Here, the deviation can manifest itself as linear movement in a direction different from the target direction or as linear movement in differing directions. Furthermore, alternatively or additionally, the deviation can also be caused by a rotational movement. In all the cases mentioned, the deviation can be only temporary, i.e. occur only at certain positions in the target direction, or at almost all positions in the target direction from the first occurrence of a deviation during the movement in the target direction. The last case particularly refers to a cumulative increase of the deviation of the movement direction from the target direction.

The deviation can be determined only at a predetermined maximum number of positions of the energy supply device in the target direction or else it is determined at as many positions as possible whether a deviation occurs. This depends entirely on the accuracy requirements in the layer-by-layer additive manufacturing of three-dimensional objects. In the last-mentioned case, the number of positions at which a deviation is determined can be coupled to the spatial resolution of the linear guide in the target direction (e.g. when using a stepping motor).

By arranging a plurality of radiation emitters in an arrangement direction (Y) transverse to the target direction (X), preferably next to one another, the electromagnetic radiation can be supplied to a plurality of positions of the building material layer to be solidified simultaneously or at least with a temporal overlap, so that in comparison to e.g. a laser scanner the solidification step for a layer can take place in a reduced time. Although the arrangement direction is preferably substantially perpendicular, preferably exactly perpendicular, to the target direction, embodiments in which the target direction and the arrangement direction enclose an angle different from 90° are also possible. Irrespective of this, it is possible for the radiation emitters to be offset with respect to one another in a direction perpendicular to the arrangement direction. Furthermore, it is also conceivable for the radiation emitters not to be arranged without gaps next to one another in the arrangement direction. Rather, it is decisive that the electromagnetic radiation can be supplied without gaps in the arrangement direction, wherein there can be exceptions also from this if, for example, it is deliberately intended not to supply electromagnetic radiation to a strip of the building field extending in the target direction. Preferably, each radiation emitter consists of a number of diode lasers such as VCSELs or VECSELs.

The control device, by which the individual components of the apparatus for the layer-by-layer additive manufacturing are controlled in a coordinated manner for carrying out the layer-by-layer additive building process, can also be arranged partially or entirely outside of the additive manufacturing apparatus. The control device preferably contains a CPU, the operation of which is controlled by a computer program (software). The computer program can be stored separately from the additive manufacturing apparatus in a memory device, from where it can be loaded into the control device (for example via a network).

In particular, the control device specifies for the individual radiation emitters at which locations in the plane parallel to the building plane the individual radiation emitters are to emit radiation during the movement of the radiation supply device over the building field. Predetermined positions of the provided layer at which building material is to be solidified correspond to these emission locations of the radiation emitters.

In the described calibration method, at positions along the target direction at which it is determined that a deviation from the target direction occurs during the movement of the energy supply device over the building plane, the control device or its software is caused to automatically assign at least some of the radiation emitters other emission locations than those which would have been assigned to these radiation emitters without the presence of a deviation. In other words, since the position of the radiation emitters in the plane parallel to the building plane changes as a result of the deviation, the control device automatically changes the locations at which radiation emitters are to emit radiation so that the emission locations correlate correctly with the predetermined positions of the building material layer to be solidified. It is therefore understood that other emission locations are not necessarily assigned to all of the radiation emitters contained in the energy supply device. Rather, other emission locations are often assigned to only some of the radiation emitters. The number of radiation emitters to which other emission locations are assigned often depends on the extent of the determined deviation.

It should also be noted that, in addition to changing the emission locations, optionally also the radiation power emitted by the radiation emitters can be changed. This refers to the case in which the radiation emitters can not only be switched on and off, but in addition the radiation power emitted by radiation emitters can be changed.

Preferably, in the calibration method the angle (αj) between the predefined target direction (X) and the movement direction (B) is detected for determining the deviation and it is decided that a deviation exists if this angle (αj) exceeds a specified tolerance angle (α_{ref}).

Depending on the accuracy requirements for the additive manufacturing of objects, sometimes it can be tolerated that the emission locations of the radiation emitters are slightly displaced due to the deviation of the direction of movement from the target direction. The tolerance with respect to slight deviations can be taken into account by specifying the tolerance angle. A change or adaptation of emission locations then takes place only in those cases in which the displacement of the emission locations with regard to the positions of the building material layer to be solidified cannot be tolerated anymore. If the deviation falls below the tolerance angle, the displacement of the emission locations resulting from the deviation is tolerated. In principle, an arbitrarily small tolerance angle) (0°) can be specified. Nevertheless, a lower limit results automatically from the measurement accuracy with which the tolerance angle can be determined.

Preferably, for determining deviations, the energy supply device is moved over the building field with or without supplying electromagnetic radiation to the predetermined positions.

When proceeding like this, it is possible to determine deviations of the movement direction from the target direction which occur during a movement of the energy supply device over the building field independently from a manufacturing process taking place in the apparatus for layer-by-layer additive manufacturing. Here, in order to determine deviations, the energy supply device is moved over the building field, preferably the entire building field, and it is checked at individual positions in the target direction whether a deviation exists between the movement direction and the target direction. Based on the result, the control device can then be changed such that it takes into account the deviations occurring in subsequent manufacturing processes at the corresponding positions of the energy supply device in the target direction by specifying other emission locations at these positions. In particular, the determination of deviations can be carried out before the first starting of the apparatus for layer-by-layer additive manufacturing or else after relatively long holding times, after modifications or after changes in the ambient conditions, e.g. changes of the ambient temperature at the installation site or a changeover to the manufacturing of other objects. Apart from this, the deviations can also be determined continuously during the manufacturing process, e.g. in order to counteract creeping changes.

Further preferably, information about positions (XJ) in the target direction (X) at which a deviation was determined is stored in a memory device and the information stored in the memory device is accessed for specifying the other emission locations of the radiation emitters.

By proceeding in this way, the control device can obtain the positions in the target direction at which a deviation occurred by an access to the memory device. The memory device can be any type of volatile or non-volatile memory. A memory device in the control device itself, e.g. a RAM, EPROM, etc., or a storage medium to which the control device can have read access, e.g. a CD-ROM or DVD, or a memory device that is arranged at a completely different location than the apparatus for the layer-by-layer additive manufacturing, wherein the access to the memory device takes place via a LAN, in particular the Internet, would be conceivable. In particular, a cloud-based implementation of the memory device would also be conceivable, which then also covers a storage on a plurality of different memory devices.

Further preferably, the apparatus for layer-by-layer additive manufacturing comprises an interface for receiving control data for controlling the procedure of a layer-by-layer additive manufacturing process, wherein the control data comprise at least one data model of the number of objects to be manufactured, in which data model it is specified for the radiation emitters at which emission locations over the building field radiation is to be emitted for supplying electromagnetic radiation to predetermined positions of a provided layer that are assigned to cross sections of the number of objects in this layer,
wherein the control device specifies other emission locations for radiation emitters by making changes in a received data model.

The control data can contain instructions to apply layers of the building material one after the other and to supply radiation to areas of the respective layers that correspond to the cross section of an object to be manufactured in order to solidify the building material there.

In detail, the control data comprise a data model that is derived from a computer-based model of the object or the objects to be manufactured, preferably a CAD model thereof. In detail, the control data specify for each building material layer at which emission locations radiation emitters are to emit radiation when moving the energy supply device over the building field in order to solidify positions of the building material layer. These emission locations are derived from a computer-based model of the object or the objects to be manufactured, preferably a CAD model thereof.

The interface for receiving control data can in particular be an interface for receiving digital data known in the prior art such as a PCI bus, an AGP, a SCSI, a USB or a FireWire interface, the list not being exhaustive.

The use of an apparatus for a layer-by-layer additive manufacturing with such an interface allows users of the apparatus to specify for the apparatus the control data with a data model for the manufacturing of the objects desired by the users. In such a case, the control device changed by the calibration method can automatically change the received data model at the positions of the energy supply device in the target direction at which a deviation was determined. In other words, the data model of the number of objects to be manufactured specified by a user is pre-deformed before the start of the manufacturing process or before each start of the irradiation process of a layer and the manufacturing process is carried out on the basis of the pre-deformed data model.

Preferably, the control device is caused to specify during an additive manufacturing process, preferably during a movement of the energy supply device over the building field, other emission locations for radiation emitters.

In this implementation of the calibration method, deviations between the movement direction and the target direction are determined during a movement of the energy supply device over the building field for supplying the radiation to the building material. Here, the presence of a deviation can be determined at each new position in the target direction that is reached by the energy supply device. If a deviation exists, the control device automatically specifies other emission locations for radiation emitters than those emission locations which would have been specified without the presence of a deviation. The control device of the additive manufacturing device is thus designed such that it either itself causes the determination of deviations or at least can receive the information about the presence of a deviation in order to automatically specify in both cases other emission locations if a deviation exists. Here, preferably, the angle between the movement direction and the target direction is also determined or communicated to the control device so that the control device then can use this information for changing emission locations.

Preferably, a deviation is determined only at a predetermined number of positions (XJ) in the target direction (X).

The positions in the target direction at which a deviation will be determined can e.g. be specified there, where it is suspected already in advance that a deviation from the linear movement can occur. Such a suspicion can result, for example, from a calibration process that has already taken place in the past or can be based on the knowledge that particularly high temperatures or particularly large temperature differences occur in certain areas of the building field during the additive manufacturing process. By such an approach, the calibration effort can be reduced.

Between the specified positions, the related deviations are determined by calculation on the basis of the deviations determined at the positions (interpolation). Furthermore, it is also possible to specify a maximum number of positions so that, as far as the boundary conditions allow this, a deviation can also be determined at a smaller number of positions in the target direction.

Preferably, a deviation is determined at positions (XJ) in the target direction (X) that have a predetermined distance (Δx) to one another.

By proceeding in this way, on the one hand the calibration effort is limited by determining the presence of a deviation only at certain positions. On the other hand, by specifying the constant distance between the positions, it is achieved that deviations are determined as uniformly as possible along the target direction.

Optionally, one can also specify a maximum distance between the positions in the target direction that must not be exceeded.

Preferably, in the calibration method it is additionally determined whether during the movement of the energy supply device there occurs a change in the distance of radiation emitters from the building field and, if this is the case, the control device is caused to change the focal position of the radiation emitted by radiation emitters.

A change of the distance of radiation emitters from the building field can be caused by the fact that the movement of the energy supply device over the build area does not take place completely within one plane, which means that the energy supply device as a whole gets displaced in a direction perpendicular to the plane in which the target direction lies. In this case, the distance of all radiation emitters changes. On the other hand, however, the plane in which the energy supply device is moved over the building field may not be completely parallel to the building plane in which the building field lies. In that case, different distances from the building field for different radiation emitters can result, so that the distance of only some of the radiation emitters changes more than by a tolerable amount.

Even if the deviations from plane parallelism are usually negligibly small, for high-precision applications this effect can also be taken into account by checking (for example by means of an (IR) camera arranged above the building field) whether fluctuations of the beam focus occur. If this is the case, the focal position can be corrected by changing the distance of the energy supply device to the building plane and/or by introducing or changing an inclination of the energy supply device with respect to the plane of the building field (the working or building plane) and/or by adapting the focusing.

An inventive apparatus for a layer-by-layer additive manufacturing of a number of objects that can be calibrated by a calibration method according to the invention comprises:
a control device for controlling the layer-by-layer additive manufacturing process,
a layer application device that is designed to provide a layer of a shapeless building material within a building field on a building base or on an already manufactured layer,
an energy supply device that is adapted to solidify predetermined positions of the provided layer that are assigned to cross sections of the number of objects in this layer by supplying electromagnetic radiation,
   wherein the energy supply device is adapted to be moved over the building field for supplying electromagnetic radiation to the predetermined positions and a predefined target direction (X) is specified for the energy supply device for this movement,
   wherein the energy supply device comprises a number of radiation emitters which are arranged along an arrangement direction (Y) transverse to the predefined target direction (X), and the control device specifies for the radiation emitters emission locations over the building field at which radiation is to be emitted, depending on the predetermined positions, and
   wherein the control device is adapted to specify other emission locations for radiation emitters at positions (XJ) in the target direction (X) at which a deviation is determined during the calibration method.

An apparatus according to the invention is configured such that it automatically changes the locations at which radiation emitters are to emit radiation in the case of deviations of the movement direction of the energy supply device from the target direction. In other words, the control device of the apparatus is configured such that it can either take into account during the manufacturing process the information about deviations determined before a manufacturing process or else gathers the information by itself during the manufacturing process and immediately takes the same into account.

Thus, the apparatus is configured such that a calibration method according to the invention can be carried out for this apparatus. Accordingly, for a user of the apparatus, in particular the prerequisite of having to calibrate the apparatus before starting or else from time to time can be dispensed with. The determination of deviations of the movement direction from the target direction can in particular be made already by the manufacturer of the apparatus or else the apparatus can do this by itself during a solidification process of a building material layer.

Preferably, the apparatus comprises a linear guide by which the energy supply device is guided during its movement over the building field.

There are several options for the configuration of the linear guide. Primarily, the linear guide can be implemented by means of a number of rails, in particular one or two rails, which serve for a straight guidance of the movement of the energy supply device. In this case, the energy supply device is connected to the rail(s) by means of a coupling device (e.g. slide or carriage).

Further preferably, the linear guide comprises two parallel rails spaced from each other, on which the movement of the energy supply device is guided by means of two slides.

Such a configuration of the linear guide has the advantage that a particularly linear movement can be ensured with it.

Further preferably, the energy supply device is arranged between rails arranged on two sides of the building field.

Such a configuration of the linear guide has the advantage that a particularly stable structure is ensured with it, wherein the energy supply device mounted on the two rails spans over the building field like a bridge.

Preferably, the inventive apparatus for a layer-by-layer additive manufacturing of a number of objects additionally comprises a position detector adapted to determine whether a deviation of a movement direction (B) of the energy supply device from the predefined target direction (X) occurs during the movement of the energy supply device.

Here, a position detector determines e.g. the angle between the movement direction of the energy supply unit and the target direction. For example, a camera can be used for this, which camera is preferably arranged above of the energy supply unit and the building field. Furthermore, the position detector can comprise a linear measuring system (e.g. a glass scale, an inductive displacement sensor, an interferometer or a combination of a linear measuring system and an angle measuring system (glass scale and autocollimator).

Preferably, the inventive apparatus for a layer-by-layer additive manufacturing of a number of objects, in which the linear guide comprises two parallel rails spaced from each other, comprises in addition a position detector adapted to determine whether a deviation of a movement direction (B) of the energy supply device from the predefined target direction (X) occurs during the movement of the energy supply device,
wherein the position detector comprises two position measuring units, each of which is attached to one of the two rails and is adapted to determine the position of the respective slide on the rail.

In this configuration, simply the positions of the coupling devices (e.g. the slides) determined at a given point in time, by which coupling devices the energy supply units are coupled to the rails, are determined and a deviation between a movement direction and the target direction is determined therefrom, for example via the distance of the position measuring units, and the angles between the movement direction of the energy supply unit and the target direction are calculated from the determined positions. Here, linear measuring systems (e.g. inductive displacement sensors, interferometers) can be considered as position measuring units.

Further preferably, the position detector is adapted to determine an angle (αj) between the predefined target direction (X) and the movement direction (B).

By determining the angle between the movement direction and the target direction, the information about the deviation that occurs can be taken into account in a simple manner when redefining emission locations, in particular when the arrangement of the radiation emitters at the energy supply device follows a complex pattern.

Further preferably, the position detector is a camera arranged above the energy supply device.

The camera can be either an optical camera, which records in particular images of the energy supply device and its linear guide, or an infrared camera, which records images of the irradiated building material layer, on the basis of which images conclusions are drawn about a deviation between the movement direction and the target direction. As a result of the energy supply, the irradiated positions of the building material layer have a higher temperature than the surrounding building material, which is reflected in the IR image. Deviations can then be determined by determining geometric deviations from the related object cross section (or a part thereof) specified in the input data of the additive manufacturing apparatus.

Further preferably, the inventive apparatus for a layer-by-layer additive manufacturing of a number of objects additionally comprises a testing unit adapted to determine the presence of a deviation if the angle (αj) detected by the position detector exceeds a specified tolerance angle (α_{ref}).

The testing unit can be implemented in particular by means of software, in particular also by means of a program executed by a CPU contained in the control device. The tolerance angle is preferably adjustable and e.g. dependent on the accuracy requirements for the objects to be manufactured. This means that either the manufacturer of the additive manufacturing apparatus can determine the accuracy of the additive manufacturing apparatus by specifying the tolerance angle or a user of the apparatus can adapt the apparatus to his requirements by changing the tolerance angle.

An inventive method for a layer-by-layer additive manufacturing of a number of objects comprises a calibration method according to the invention.

By means of such a layer-by-layer additive manufacturing method, the accuracy of the manufactured objects can be improved in a simple manner.

Further features and advantages of the invention are apparent from the description of exemplary embodiments with reference to the attached figures.

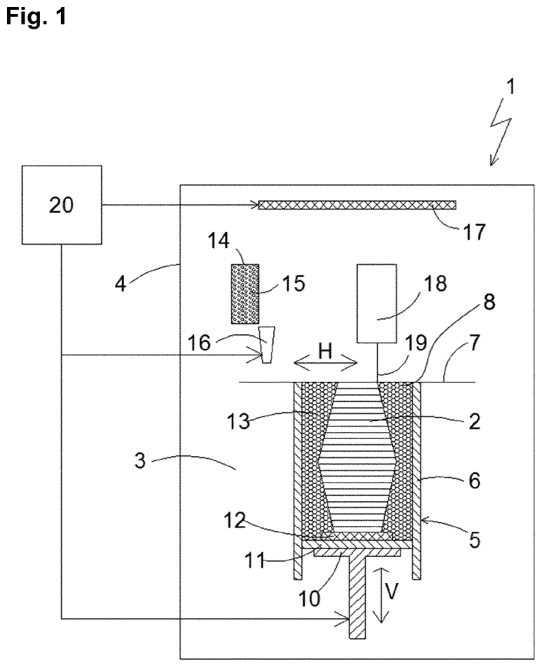

FIG. 1 shows a schematic view, partially illustrated in section, of an exemplary apparatus for the additive manufacture of a three-dimensional object according to the invention.

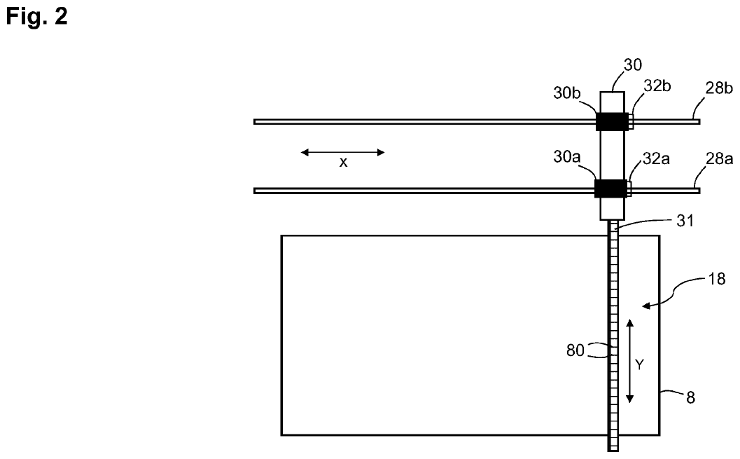

FIG. 2 shows a schematic top view of a building field with a line exposure device to which the present invention can be applied.

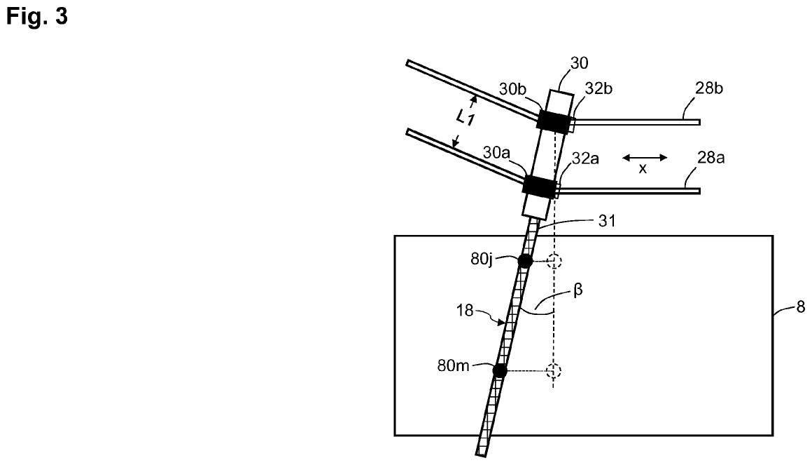

FIG. 3 schematically illustrates the problem solved by the invention.

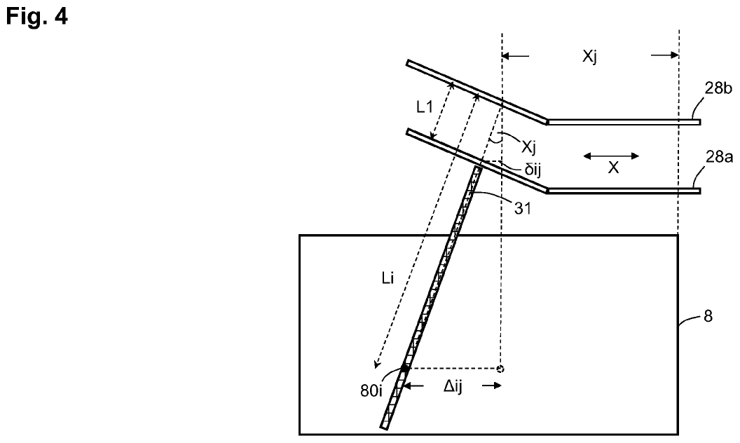

FIG. 4 serves for explaining an approach according to the invention.

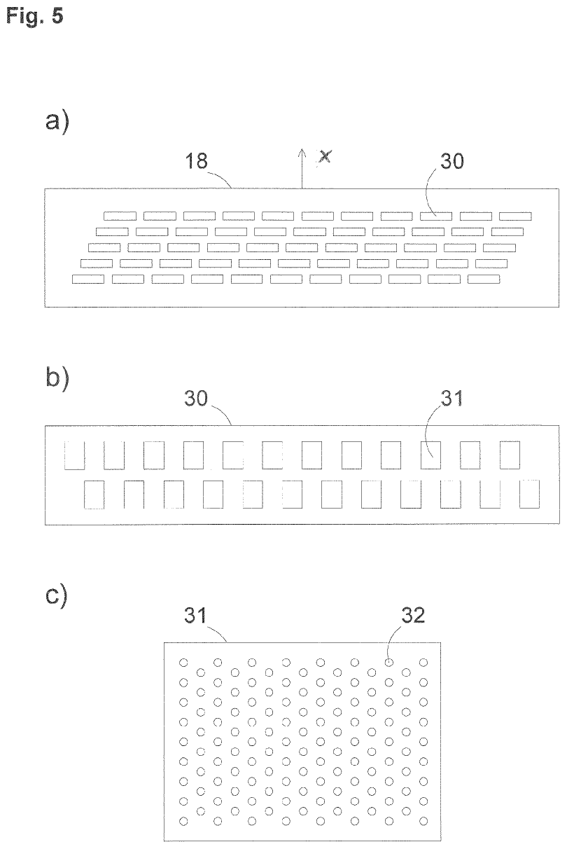

FIG. 5a is a schematic view from below of an exposure device contained in the apparatus shown in FIG. 1.

FIG. 5b is a schematic view of a laser module contained in the exposure device shown in FIG. 5a.

FIG. 5c is a schematic view of a laser array contained in the laser module shown in FIG. 5b.

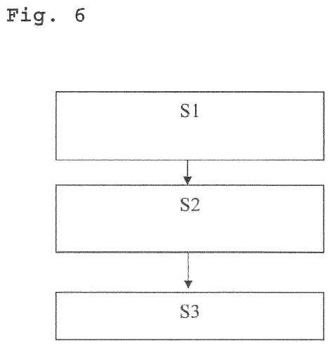

FIG. 6 illustrates the sequence of a calibration method according to a first embodiment,

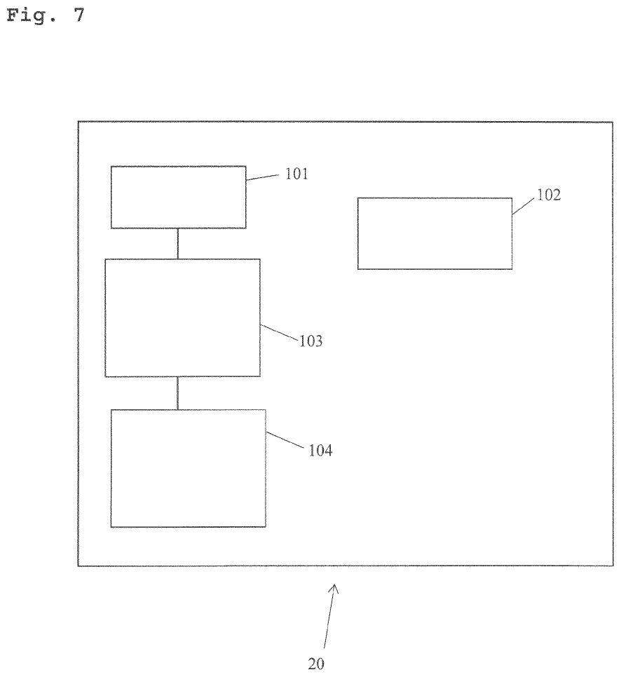

FIG. 7 schematically shows details of the setup of a control device of an additive manufacturing apparatus according to a first embodiment.

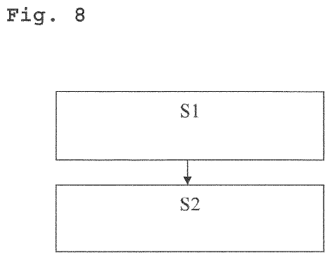

FIG. 8 illustrates the sequence of a calibration method according to a second embodiment,

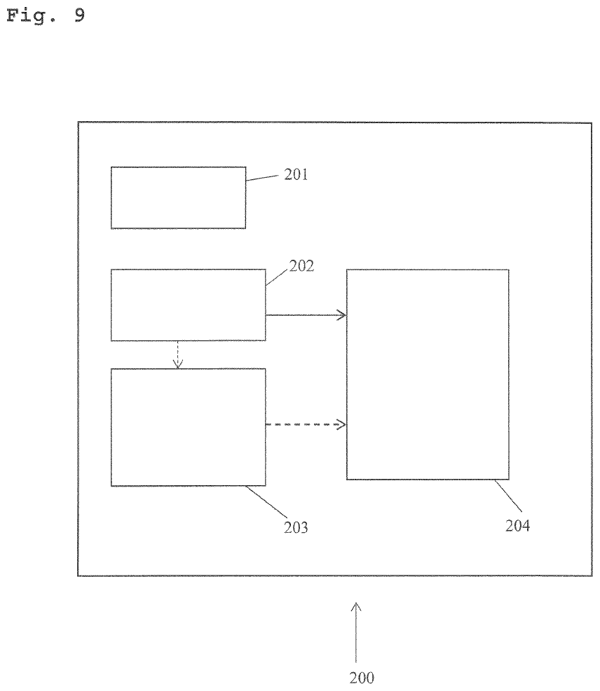

FIG. 9 schematically shows details of the setup of a control device of an additive manufacturing apparatus according to a second embodiment.

In the following, at first an exemplary apparatus 1 which is calibrated in accordance with the two embodiments of the present invention is described with reference to FIG. 1. The apparatus shown in FIG. 1 is a laser sintering or laser melting apparatus 1. For building an object 2, it contains a process chamber 3 having a chamber wall 4.

A container 5 which is open to the top and has a container wall 6 is arranged in the process chamber 3. A working plane 7 is defined by the upper opening of the container 5, wherein the area of the working plane 7 that lies within the opening and can be used for building the object 2 is referred to as building field 8.

A carrier 10 which is movable in a vertical direction V is arranged in the container 5, to which carrier a base plate 11 is attached, which closes the container 5 to the bottom and thus forms the bottom thereof. The base plate 11 can be a plate which is formed separately from the carrier 10 and is fastened to the carrier 10, or it can be formed integrally with the carrier 10. Depending on the powder and process used, a building platform 12 can be attached to the base plate 11 as a building base on which the object 2 is built. However, the object 2 can also be built directly on the base plate 11, which then serves as a building base. FIG. 1 shows the object 2 to be formed in the container 5 on the building platform 12 below the working plane 7 in an intermediate state with a plurality of solidified layers, surrounded by building material 13 which has remained unsolidified.

The laser sintering device 1 further contains a storage container 14 for a building material 15 that is in powder form or paste-like and can be solidified by electromagnetic radiation and a layer application device 16 which is movable in a horizontal direction H in order to apply the building material 15 within the building field 8. Preferably, the layer application device 16 extends transversely to its direction of movement over the entire area to be coated.

Optionally, a radiation heater 17 is arranged in the process chamber 3 and serves for heating the applied building material 15. For example, an infrared radiator can be provided as radiation heater 17.

As energy supply device for supplying electromagnetic radiation to the building material, the laser sintering device 1 further comprises an exposure device 18 which is also movable in a horizontal direction and generates laser radiation 19 that is focused onto the working plane 7. The exposure device 18 is configured as a line exposure device which is capable of exposing an area extending transversely, in particular perpendicularly, to its direction of movement, which area is also referred to as a line and extends over the entire region to be exposed.

FIG. 2 shows a schematic top view of the building field 8 illustrating the line exposure device 18 to be moved in the target direction X. This line exposure device has an exposure arm 31 with a longitudinal axis extending perpendicularly to the target direction X. To guide the movement of the line exposure device 18, the exposure arm 31 is rigidly connected to a coupling device 30 which is arranged in the extension of the longitudinal axis of the former. Two slides 30a and 30b are attached to the coupling device 30, each of which can be moved in a sliding manner along one of the two rails 28a and 28b that are parallel to one another. To register the position of each slide along the direction of extension (trajectory) of its rail, a position measuring unit 32a or 32b is attached to each of the two slides. The motor for moving the exposure device 18 (e.g. a stepping motor) is not shown in the figures for reasons of clarity.

In this example, the line exposure device 18 has a plurality of exposure units (i.e. radiation emitters) 80 which can be controlled independently of one another, are arranged next to one another perpendicularly to the direction of movement of the line exposure device (designated as the Y direction in FIG. 2) and each are able to direct laser radiation independently of one another onto the working plane 7 lying below the line exposure device 18. In this example, it is assumed that n exposure units 80₁, 80₂, . . . 80ₙ are present, wherein n is a natural number and, for example, has the value 184. In the further course of the description, it will be assumed that the exposure unit 80₁ has the smallest distance from the rail 28a and the exposure unit 80ₙ has the largest distance.

Referring again to FIG. 1, the laser sintering apparatus 1 comprises a control device 20, by which the individual components of the apparatus 1 (e.g. the motor for moving the exposure device 18) are controlled in a coordinated manner for carrying out the building process. Alternatively, the control device can also be arranged partially or entirely outside of the apparatus. The control device may contain a CPU, the operation of which is controlled by a computer program (software). The computer program can be stored on a storage medium, from where it can be loaded into the apparatus, in particular into the control device. In the present application, the term “control device” includes any computer-based control device which is capable of open-loop or closed-loop control of the operation of an additive manufacturing apparatus or at least one of its components. Here, the connection between the control device and controlled components does not necessarily have to be cable-based, but can also be implemented by means of radio communication, in that the control device comprises corresponding radio receivers and transmitters.

In the additive manufacturing apparatus just described by way of example, a manufacturing process takes place such that the control device 20 processes a control data set that is read by the control device. For each layer of the building material 15 applied by the layer application device 16, the control data set specifies at which positions within the building field 8 laser radiation is to be directed onto the working plane 7 (and thus onto the building material 15). This means that the control data set specifies at which positions Xj of the exposure device 18 in the target direction X which exposure units 80₁ . . . 80ₙ on the exposure arm 31 are to emit laser radiation. The specification of the respective exposure unit 80ᵢ in the control data set corresponds to the location of the position to be irradiated in a direction perpendicular to the target direction X. In other words, by specifying data triples (Xj, 80ᵢ, Pij), locations above the building field at which radiation is to be emitted with the power P are specified in the control data set. For the sake of simplicity, it is assumed here that either radiation is emitted or not, in other words either the power P is supplied or no power is supplied at all, i.e. Pij is a binary parameter. If no power is supplied, P has the value zero.

For each layer during the layer-by-layer manufacture of an object, the control device 20 causes the layer application device 16 to apply a layer of the building material 15 in order to subsequently move the line exposure device 18 by means of a linear guide in the target direction X over the building field 8 and to control it in accordance with the specifications in the control data set for the selective exposure of the building material.

According to the invention, deviations of the direction in which the linear guide moves the exposure device 18 over the building field 8 from the target direction X are determined and the additive manufacturing apparatus is calibrated such that it automatically takes into account such deviations during additive manufacturing processes of objects.

FIG. 3 schematically illustrates the problem solved by the invention. Like FIG. 2, also FIG. 3 shows a schematic top view of the building field 8 with the line exposure device 18 to be moved in the target direction X. Here, features in FIG. 3 that are identical to those in FIG. 2 are provided with the same reference signs. The straightness of the movement of the exposure device 18 depends on the straightness of the rails 28a and 28b serving for the linear guidance. Especially in the case of a rail length/building field length in the range of approximately 50 cm, it cannot be excluded that manufacturing tolerances lead to deviations from the straightness. Here, for reasons of illustration, a deviation of the straightness of the rails is shown exaggerated in FIG. 3. As can be seen, during the movement of the exposure device 18 in the target direction X, the curvature of the rails causes an additional rotational movement by the angle β. As a result, the exposure units in the target direction do not assume a position Xj that is specified in the control data set. In particular, the offset of the exposure units in the X direction is also dependent on the distance of an exposure unit from the rails, which is illustrated in FIG. 3 by means of the exposure units 80ⱼ and 80ₘ. For the exposure units 80ⱼ and 80ₘ, the locations at the position Xj, which the exposure units 80ⱼ and 80ₘ would assume for an exactly linear movement of the exposure device 18 in the target direction, are shown by dashed lines. The effect of the offset of the exposure units is that exposure units emit laser radiation at locations other than those that are specified for them, so that construction defects are caused. It should be noted that in the event that the power P supplied to the material is not specified binarily but by more than two levels, construction defects likewise result due to the fact that at individual positions in the working plane 7 the incorrect power is supplied to the building material.

It should also be noted that the just-described configuration and functioning of the control device 20 do not only apply to the following first embodiment but do also apply to the control device 200 of the second embodiment described further below.

### FIRST EMBODIMENT

In the first embodiment, deviations of the direction in which the linear guide moves the exposure device 18 over the building field 8 from the target direction X are determined before the start of a manufacturing process and the additive manufacturing apparatus is calibrated such that it automatically takes into account such deviations during additive manufacturing processes of objects.

For carrying out the calibration method, it is necessary that a control device 20 of the additive manufacturing apparatus is configured in a special manner. In the following, the procedure of the calibration method is described with reference to FIG. 6 with FIG. 7 illustrating relevant details of the setup of the control device 20.

In step S1 shown in FIG. 6, before the start of the manufacturing process of an object, the exposure device 18 is moved along the rails 28a and 28b across the entire building field 8. Here, at selected positions Xj in the target direction X, the values given by the position measuring units 32a or 32b are compared with each other. If at a position Xj the difference δj of the values given by the position measuring units 32a or 32b exceeds a tolerance value, such difference δj is converted into an angle αj. Here, arctan (δj/L1) results for the angle αj, wherein L1 is the distance of the rails perpendicular to the direction of extension of the rails. Subsequently, the angle αj is stored together with the related position Xj in a deviation table.

The selected positions Xj are preferably selected such that they as far as possible cover the entire length of the building field 8 in the target direction X. The closer the positions Xj are to each other, in other words the larger the number of selected positions, the more precisely deviations from the linear course can be detected. Here, for a high tolerance value, a smaller number of positions Xj will be sufficient than for a low tolerance value. It should be noted that a tolerance angle corresponds to the tolerance value specified in advance in accordance with the relation: tolerance angle=arctan (tolerance value/L1).

In step S2 shown in FIG. 6, correction data are calculated from the pairs of values stored in the deviation table and are stored in a correction data table. Such correction data table contains correction data triples (Xj, 80ᵢ, Δij) in which, for each of the positions Xj, each of the exposure units 80ᵢ (1≤i≤n) is assigned a position error Δij that indicates the difference in the X direction between the actual position of the exposure unit 80ᵢ and the position Xj.

With reference to FIG. 4, it is explained in the following how the position error Δij is determined for an exemplary exposure unit 80ᵢ. Here, in FIG. 4, compared to FIG. 3, those features are omitted that are not necessary for the explanation. Otherwise, features that are identical to those in FIG. 3 are provided with the same reference signs. FIG. 4 shows the position of the exposure unit 80ᵢ along the direction of the longitudinal axis of the exposure arm 31, wherein Li indicates the distance of the exposure unit 80ᵢ from the rail 28b. Here, it is assumed that the longitudinal axis of the exposure arm extends perpendicularly to the rail 28b. It can be seen that the position error Δij can be calculated as Δij=Li·sin αj.

As shown in FIG. 7, the control device 20 contains, inter alia, a control data access unit 101, a correction data storage unit 102, a control data correction unit 103 and an exposure device control unit 104. In step S3 shown in FIG. 6, the correction data table previously generated in step S2 is stored in the correction data storage unit 102 of the control device 20. As can be seen in FIG. 7, the control data correction unit 103 is connected between the control data access unit 101 and the exposure device control unit 104. As a result, after reading in a control data set with the control data for the manufacture of a number of cross sections of an object, optionally for the entire object, which is done by the control data access unit 101, the control data correction unit 103 can carry out the following steps (i) to (ii), so that the exposure device control unit 104 does not automatically carry out an irradiation based on the read-in control data triples.

In step i), it is checked for each of the control data triples (Xj, 80ᵢ, Pij) specified in the control data set whether a correction data triple (Xj, 80ᵢ, Δij) is stored for the position Xj in the control data triple in the correction data storage unit 102. Step ii) is carried out for the control data triples for which this is the case.

In step ii), the corresponding control data triple is changed to (Xj, 80ᵢ, Pi(Xj+Δij)). In other words, the value of Pij that was originally specified for an exposure unit 80ᵢ arranged at the location Xj is set to a value that was originally specified for an exposure unit 80ᵢ arranged at the location Xj+Δij.

The exposure device control unit 104 can now take the control data set changed in this way as a basis (possibly after intermediate storage) for controlling the exposure device 18. In this case, in a manufacturing process in the additive manufacturing apparatus, before the start of construction at first a changed control data set is generated. Alternatively, it is also possible to first change the control data related to a layer before the irradiation of this layer (e.g. during layer application).

### SECOND EMBODIMENT

In the second embodiment, deviations of the direction in which the linear guide moves the exposure device 18 over the building field 8 from the target direction X are determined during a manufacturing process. The additive manufacturing apparatus thus calibrates itself during additive manufacturing processes of objects by determining such deviations during additive manufacturing processes and automatically taking them into account when irradiating a layer of the building material. For this, the additive manufacturing apparatus has a control device 200.

In the following, the procedure of the calibration method is described with reference to FIG. 8, wherein FIG. 9 illustrates relevant details of the setup of the control device 200 that is configured for a corresponding calibration.

In step S1 shown in FIG. 8, the control data access unit 201 shown in FIG. 9 first reads in a control data set that contains the control data for the manufacture of a number of cross sections of an object, optionally for the entire object. In step S2, the layer application device 16 is then caused to apply a layer of the building material 15 in order to subsequently move the line exposure device 18 in the target direction X over the building field 8 and to control it in accordance with the specifications in the control data set for the selective exposure of the building material. The components of the control device 200 required for this are known in the prior art and therefore are not explicitly shown in FIG. 9.

Nevertheless, step S2 additionally contains a sub-step which like this is not known in the prior art. During the movement of the exposure device 18, the values given by the position measuring units 32a or 32b are read out and compared to each other by the deviation determination unit 202 shown in FIG. 9. If at a position Xj the difference δj of the values given by the position measuring units 32a or 32b exceeds a tolerance value, then the values specified for the exposure unit 80ᵢ in the control data for this position Xj are changed by a control data correction unit 203 shown in FIG. 9. The approach is explained with reference to FIG. 4 for an exemplary exposure unit 80ᵢ.

As in the first embodiment, for each position Xj of the line exposure device 18 during its movement in the target direction X, a position error Δij is determined that indicates the difference in the X direction between the actual position of the exposure unit 80ᵢ and the position Xj. For this, as in the first embodiment, the difference δj can be converted into an angle αj and Δij can be determined therefrom as Δij=Li·sin αj. Alternatively, however, Δij can also be determined directly to be Δij=L/L1·δj, which is also possible in the first embodiment. Use is made here of the fact that the deviations from the straightness are so minimal that, to a good approximation, the difference δj given by the position measuring units 32a or 32b, which relates to different positions along the trajectories of the rails 28a and 28b, is equal to the difference of these positions in the target direction X.

If it is determined at a position Xj that the difference 67 j of the values given by the position measuring units 32a or 32b exceeds a tolerance value, the control data triples, which define the control of the exposure devices 80i at the position Xj, are changed in that the control data triples (Xj, 80ᵢ, Pij) (1≤i≤n) are replaced by data triples (Xj, 80ᵢ, Pi(Xj+Δij)). The modified data triples (Xj, 80ᵢ, Pi(Xj+Δij) (1≤i≤n) are now made available to the exposure device control unit 204 for the selective irradiation of the building material at the exposure position Xj.

If the above-mentioned comparison of the values given by the position measuring units 32a or 32b which is carried out by the deviation determination unit 202 does not result in the tolerance value being exceeded, the deviation determination unit 202 passes on the read-in control data triples (Xj, 80ᵢ, Pij) (1≤i≤n) that relate to an exposure position Xj in the target direction directly to the exposure device control unit 204 without involving the control data correction unit 203.

In this way, during the movement of the line exposure device 18 over a layer of the building material, at each position Xj first the position measuring units 32a or 32b are checked before the line exposure device 18 supplies radiation to the building material at the position Xj.

### MODIFICATION OF THE EMBODIMENTS

It turned out that the approach described in the two embodiments is particularly advantageous when a line exposure device is used in which exposure units 80 are arranged next to one another not only transversely to the target direction X but also in the target direction X. In the following, an example of such an exposure device will be described:

FIGS. 5a to 5c schematically show a view of the exposure device 18 from below. The direction of movement of the exposure device over the building field is indicated by an arrow X. FIG. 5a shows how a plurality of laser modules 30 are arranged in rows offset with respect to each other on the underside of the exposure device 18. FIG. 5b shows how each laser module 30 is formed from a plurality of laser arrays 31 which constitute the exposure units or radiation emitters 80. FIG. 5c shows how each laser array 31 is formed from a plurality of individual lasers 32.

The individual lasers 32 are constructed as semiconductor diode lasers of the VCSEL (vertical cavity surface-emitting laser) or VECSEL (vertical external cavity surface-emitting laser) type. These laser sources have an emission direction perpendicular to the main extension (wafer plane) and have a circularly symmetrical beam divergence and are particularly well suited for an arrangement in two-dimensional arrays. In the laser array 31 shown in FIG. 5c, the individual lasers 32 are arranged hexagonally, however, any other arrangement is possible. All lasers 32 of a laser array 31 are preferably driven simultaneously. The smallest individually controllable exposure unit 80 of the exposure device 18 is then the laser array 31. This has the advantage that, in the event of a failure of an individual laser, not a complete exposure unit fails as a result therof, but rather the power drop can be compensated by the other lasers of the laser array.

A plurality of laser arrays 31 are combined to form one laser module 30. Furthermore, an optical element (not shown in the figure) is provided for each laser module 30, by which optical element the laser arrays 31 are imaged onto the working plane 7. Here, each laser array 31 is imaged onto an image point (pixel) in the working plane 7. Each laser module 30 is directed onto a certain area in the working plane 7. When the exposure device 18 is moved in the target direction X, the image points of the switched-on laser arrays 31 form a track.

In the laser module 30 shown in FIG. 5b, the individual laser arrays 31 are arranged in two staggered rows such that the tracks of their image points adjoin each other in the working plane during a movement of the laser module 30 in the target direction X. If, for example, the laser arrays 31 have a width of 0.1 mm transversely to the target direction X (i.e. transversely to the intended direction of movement of the exposure device) and the optical element has a demagnifying imaging scale of 1:5, then the adjoining tracks of the laser arrays 31 will have a width of 0.02 mm. In other words, in a direction transverse to its intended direction of movement the exposure device 18 has a resolution of 0.02 mm.

In order to exploit the entire width of the exposure device 18, a plurality of laser modules 30 are arranged in a row along the direction transverse to the target direction X. Due to the optical demagnification of the laser modules 30 by the optical element, the overall width of a track formed by the image points of all laser arrays 31 of the laser module 30 during a movement of a laser module 30 in the target direction is narrower by the demagnification scale than the laser module 30 itself. However, the spacing of the tracks of all laser modules in a row, meaning the center-to-center distance of the tracks, corresponds to the (not demagnified) spacing of the laser modules 30. Thus, between the tracks that can be exposed by a single row of laser modules 30 there remains a non-exposable area.

Therefore, in order to enable a continuous exposure of the working plane in the direction transverse to the target direction X, a plurality of rows of laser modules 30 are staggered with respect to each other. In other words, individual cascades of laser modules 30 are formed, which lie one behind the other in the target direction X, but are offset with respect to each other in the direction transverse to the target direction X. In FIG. 5a, for example, the laser modules 30 of the five rows lying furthest to the left form a cascade. Several such cascades are then arranged next to each other along the direction transverse to the target direction X. Within each cascade, the laser modules 30 are displaced by such an amount that the tracks of the image points of their laser arrays 31 adjoin each other.

For example, a just described line exposure device can contain 108 laser modules, each laser module can contain 32 laser arrays (exposure units), and each laser array can contain 282 VCSELs. In this case, the exposure device comprises 3456 individually controllable exposure units (laser arrays).

It should also be mentioned that an angle between the movement direction of the energy supply unit and the target direction can also be determined by means of an autocollimator which emits a measuring beam in parallel to the building plane.

Finally, it should also be mentioned that a deviation of the movement direction of the energy supply unit from the target direction not only results in an offset of the exposure units in the X direction, but also in an offset in the Y direction (i.e. in a plane parallel to the building plane perpendicular to the X direction) which, however, is smaller by at least a factor of 10 than the offset in the X direction and is therefore usually negligible. Should, nevertheless, in an exceptional case, the offset in the Y direction be of the order of magnitude of the distance of the exposure units in the Y direction, then for a correction the values of Pij can be offset in the Y direction, i.e. the value Pij originally assigned to an exposure unit can be assigned to the exposure unit adjacent in the Y direction.

Finally, it should also be mentioned that in addition to the described software compensation of deviations, a compensation by means of hardware is also possible. For this purpose, e.g. (especially in the case of the correction of an offset in the Y direction), the position of the optical element can be changed. A configuration of the optical element as an array of spatial light modulators, which could be adapted accordingly in their properties, would also be conceivable.

1. A calibration method of an apparatus for a layer-by-layer additive manufacturing of a number of objects, the apparatus comprising:
a control device for controlling the layer-by-layer additive manufacturing process,
a layer application device which is adapted to provide a layer of a shapeless building material within a building field on a building base or on an already manufactured layer, and
an energy supply device which is adapted to solidify predetermined positions of the provided layer that are assigned to cross sections of the number of objects in this layer by supplying electromagnetic radiation,
wherein the energy supply device is adapted to be moved over the building field for supplying electromagnetic radiation to the predetermined positions and a predefined target direction is specified for the energy supply device for this movement, and
wherein the energy supply device comprises a number of radiation emitters which are arranged along an arrangement direction transverse to the predefined target direction, and the control device specifies for the radiation emitters emission locations over the building field at which radiation is to be emitted, depending on the predetermined positions,
wherein in the calibration method it is determined, whether a deviation of a movement direction of the energy supply device from the predefined target direction occurs in the movement of the energy supply device, and
wherein the control device is caused to specify other emission locations for radiation emitters depending on a determined deviation.

2. The calibration method according to claim 1, wherein the angle between the predefined target direction and the movement direction is detected for determining the deviation and it is decided that a deviation exists if this angle exceeds a specified tolerance angle.

3. The calibration method according to claim 1, wherein for determining deviations, the energy supply device is moved over the building field with or without supplying electromagnetic radiation to the predetermined positions.

4. The calibration method according to claim 3, wherein information about positions in the target direction at which a deviation was determined is stored in a memory device and the information stored in the memory device is accessed for specifying the other emission locations of the radiation emitters.

5. The calibration method according to claim 4, wherein the apparatus for layer-by-layer additive manufacturing comprises an interface for receiving control data for controlling the procedure of a layer-by-layer additive manufacturing process, wherein the control data comprise at least one data model of the number of objects to be manufactured, in which data model it is specified for the radiation emitters at which emission locations over the building field radiation is to be emitted for supplying electromagnetic radiation to predetermined positions of a provided layer that are assigned to cross sections of the number of objects in this layer,
wherein the control device specifies other emission locations for radiation emitters by making changes in a received data model.

6. The calibration method according to claim 1, wherein the control device is caused to specify during an additive manufacturing process, during a movement of the energy supply device over the building field, other emission locations for radiation emitters.

7. The calibration method according to claim 1, wherein a deviation is determined only at a predetermined number of positions in the target direction.

8. The calibration method according to claim 1, wherein a deviation is determined at positions in the target direction that have a predetermined distance to one another.

9. The calibration method according to claim 1, wherein it is additionally determined whether during the movement of the energy supply device there occurs a change in the distance of radiation emitters from the building field and, if this is the case, the control device is caused to change the focal position of the radiation emitted by radiation emitters.

10. An apparatus for a layer-by-layer additive manufacturing of a number of objects that can be calibrated according to a calibration method according to claim 1, the apparatus comprising:
a control device for controlling the layer-by-layer additive manufacturing process,
a layer application device that is designed to provide a layer of a shapeless building material within a building field on a building base or on an already manufactured layer,
an energy supply device that is adapted to solidify predetermined positions of the provided layer that are assigned to cross sections of the number of objects in this layer by supplying electromagnetic radiation,
wherein the energy supply device is adapted to be moved over the building field for supplying electromagnetic radiation to the predetermined positions and a predefined target direction is specified for the energy supply device for this movement,
wherein the energy supply device comprises a number of radiation emitters which are arranged along an arrangement direction transverse to the predefined target direction, and the control device specifies for the radiation emitters emission locations over the building field at which radiation is to be emitted, depending on the predetermined positions, and
wherein the control device is adapted to specify other emission locations for radiation emitters at positions in the target direction at which a deviation is determined during the calibration method.

11. The apparatus according to claim 10, comprising a linear guide by which the energy supply device is guided during its movement over the building field.

12. The apparatus according to claim 11, wherein the linear guide comprises two parallel rails spaced from each other, on which the movement of the energy supply device is guided by means of two slides.

13. The apparatus according to claim 12, wherein the energy supply device is arranged between rails arranged on two sides of the building field.

14. The apparatus according to claim 10, further comprising:
a position detector adapted to determine whether a deviation of a movement direction of the energy supply device from the predefined target direction occurs during the movement of the energy supply device.

15. The apparatus according to claim 12, further comprising:
a position detector adapted to determine whether a deviation of a movement direction of the energy supply device from the predefined target direction occurs during the movement of the energy supply device,
wherein the position detector comprises two position measuring units, each of which is attached to one of the two rails and is adapted to determine the position of the respective slide on the rail.

16. The apparatus according to claim 14, wherein the position detector is adapted to determine an angle between the predefined target direction and the movement direction.

17. The apparatus according to claim 14, wherein the position detector is a camera arranged above the energy supply device.

18. The apparatus according to claim 14, further comprising:
a testing unit adapted to determine the presence of a deviation if the angle detected by the position detector exceeds a specified tolerance angle.

19. A method for a layer-by-layer additive manufacturing of a number of objects comprising a calibration method according to claim 1.
